(19) United States
(12) Patent Application Publication
(10) Pub. No.: US 2025/0275051 A1
(43) Pub. Date: Aug. 28, 2025

(54) TORCH WITH MOVABLE EMISSIVE INSERT

(71) Applicant: The ESAB Group Inc., North Bethesda, MD (US)

(72) Inventor: Secundino Miguel Baldonado, Hopkinton, NH (US)

(21) Appl. No.: 18/586,009

(22) Filed: Feb. 23, 2024

(51) Int. Cl. H05H 1/34

(52) U.S. Cl. CPC H05H 1/3494; H05H 1/3447

(57) ABSTRACT

A plasma torch includes a nozzle with an opening and an electrode disposed interiorly of the nozzle and configured to generate a plasma arc and direct the plasma arc through the opening of the nozzle. The electrode includes an electrode body and an emissive insert disposed in the electrode body. The emissive insert is movable relative to the electrode body.

### TECHNICAL FIELD

The present disclosure is directed toward cutting torches and, in particular, to a movable emissive insert of an electrode of a cutting torch.

### BACKGROUND

A torch, such as a cutting torch, is used to perform various operations with respect to a metal workpiece. For example, the torch may be used to remove material from the metal workpiece for a cutting operation. The torch includes a torch body and at least one consumable component. The torch body is configured to couple to a power supply, and the consumable component is configured to couple to the torch body. The power supply is configured to direct a gas flow to the torch body, which directs the gas flow to the consumable component so that the gas flow can be utilized during the cutting or welding operation (e.g., to generate plasma, to shield a weld or arc).

The consumable component includes an electrode with an emissive insert used to shield a remainder of the electrode from heat to maintain a structural integrity of the electrode. Unfortunately, the emissive insert may deteriorate over time. For example, heat generated by the arc may remove material from the emissive insert, thereby changing a geometry of the emissive insert and impacting performance of the torch (e.g., by reducing heat shielding of the electrode). The changed geometry of the emissive insert may accelerate additional wear of the emissive insert, further reducing heat shielding provided by the emissive insert.

### SUMMARY

The present disclosure is directed towards an emissive insert that is movable within an electrode of a plasma torch. These techniques may be embodied as a plasma torch and/or an electrode of a plasma torch.

In accordance with at least one embodiment, the present application is directed to a plasma torch. The plasma torch includes a nozzle with an opening and an electrode disposed interiorly of the nozzle and configured to generate a plasma arc and direct the arc through the opening of the nozzle. The electrode includes an electrode body and an emissive insert disposed in the electrode body. The emissive insert is movable relative to the electrode body.

Other systems, methods, features and advantages will be, or will become, apparent to one with skill in the art upon examination of the following figures and detailed description. All such additional systems, methods, features and advantages are included within this description, are within the scope of the claimed subject matter.

### BRIEF DESCRIPTION OF THE DRAWINGS

The techniques presented herein may be better understood with reference to the following drawings and description. It should be understood that some elements in the figures may not necessarily be to scale and that emphasis has been placed upon illustrating the principles disclosed herein. In the figures, like-referenced numerals designate corresponding parts/steps throughout the different views.

FIG. 1A is a perspective view of an automated cutting system that may execute the techniques presented herein, according to an example embodiment of the present disclosure.

FIG. 1B is perspective view of an automated cutting head that may be included in the automated cutting system illustrated in FIG. 1A, according to an example embodiment of the present disclosure.

FIG. 1C is a schematic, cross-sectional view of an end portion of a plasma torch.

FIG. 2 illustrates a cross-sectional view of an embodiment of a consumable assembly utilized by the torch assembly illustrated in FIGS. 1A and 1B, according to an example of the present disclosure.

FIG. 3 illustrates a cross-sectional view of an embodiment of an electrode of a plasma torch, the electrode being in a first configuration, according to an example of the present disclosure.

FIG. 4 illustrates the electrode of FIG. 2 in a second configuration, according to an example of the present disclosure.

FIG. 5 illustrates the electrode of FIGS. 2 and 3 in a third configuration, according to an example of the present disclosure.

FIG. 6 illustrates a flowchart of an embodiment of a method for adjusting an electrode of a plasma torch, according to an example of the present disclosure.

### DETAILED DESCRIPTION

The following description is not to be taken in a limiting sense but is given solely for the purpose of describing the broad principles of the present application. Embodiments of the present application will be described by way of example, with reference to the above-mentioned drawings showing elements and results of such embodiments.

The present disclosure is directed to a plasma torch with an adjustable electrode. For example, the electrode may include a body and an emissive insert disposed in the body. During operation of the plasma torch, the electrode generates and maintains an arc used to melt a metal workpiece to remove material from the metal workpiece. The emissive insert extends approximately in alignment with an external face of the body to shield the body from the heat of the arc to maintain a structural integrity of the body and prolong a useful lifespan of the electrode. Unfortunately, the emissive insert may wear over time. For instance, heat generated by the arc may erode part of the emissive insert. As a result, the emissive insert may not fully extend to the external face of the body of the electrode, such as after a threshold quantity of cuts or cutting operations have been performed by the plasma torch. Consequently, heat shielding of the body may be reduced. Furthermore, the misalignment or offset between the emissive insert and the external face may increase additional wear of the emissive insert. As an example, a space may be formed between the emissive insert and the external surface of the body, and the space may create a vacuum or suction pressure during operation of the plasma torch to urge removal of material from the emissive insert.

To mitigate the misalignment between the emissive insert and the external surface of the body, the emissive insert is movable relative to the body. Thus, the emissive insert may be moved to maintain alignment between the emissive insert and the external surface of the body. By way of example, the emissive insert may be pushed to move the emissive insert toward the external surface to reduce the space that otherwise may be caused by wear of the emissive insert. Therefore, desirable heat shielding of the body may be maintained and/or further wear of the emissive insert may be impeded. Consequently, a useful lifespan of the electrode may be prolonged.

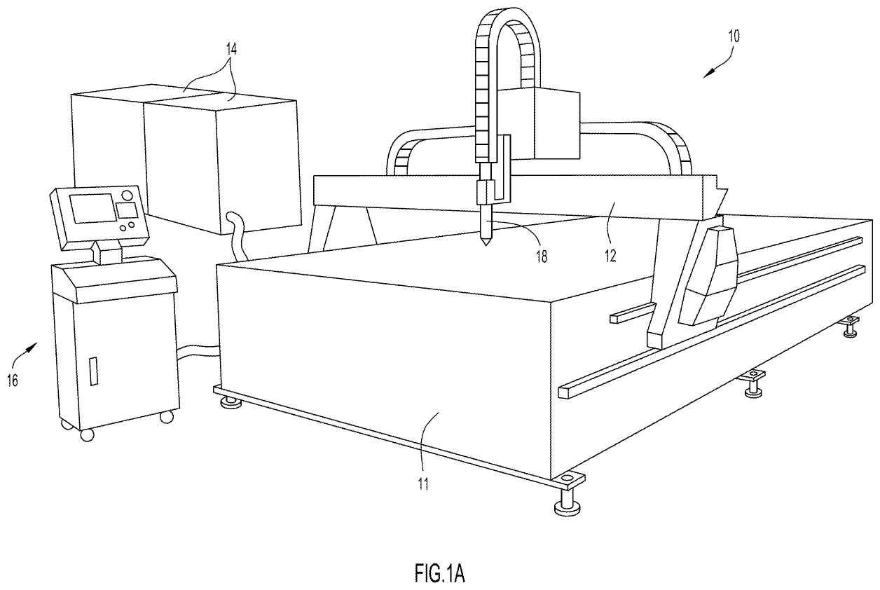

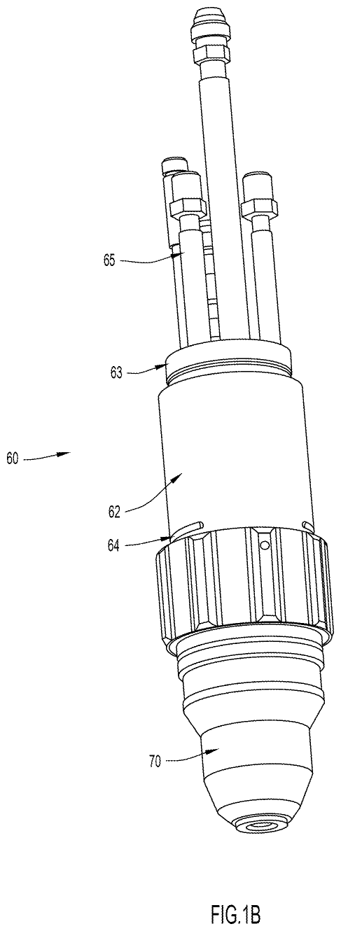

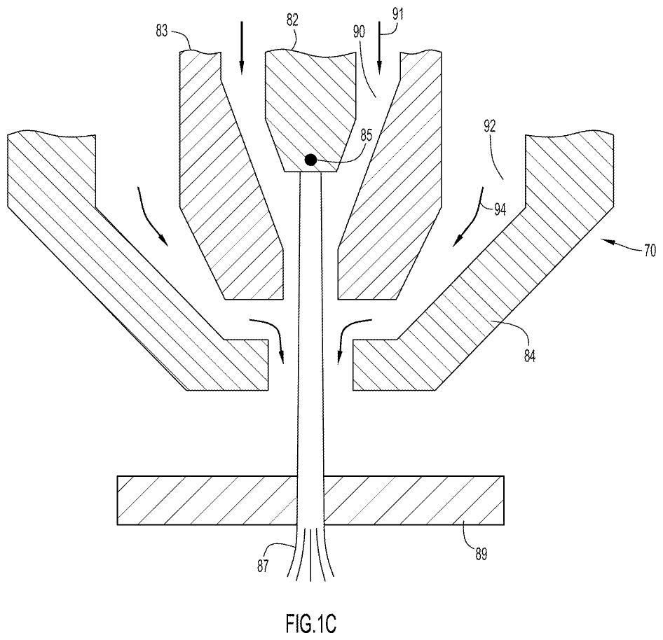

FIG. 1A illustrates an example embodiment of an automated cutting system 10 that may execute the techniques presented herein. However, this automated cutting system 10 is merely presented by way of example and the techniques presented herein may also be executed by manual cutting systems and/or automated cutting systems that differ from the automated cutting system 10 of FIG. 1A (e.g., any robotic or partially robotic cutting system). That is, the cutting system 10 illustrated in FIG. 1A is provided for illustrative purposes.

At a high-level, the cutting system 10 includes a table 11 configured to receive a workpiece (not shown), such as, but not limited to, sheets of metal. The automated cutting system also includes a positioning system 12 that is mounted to the table 11 and configured to translate or move along the table 11. At least one automated plasma arc torch 18 is mounted to the positioning system 12 and, in some embodiments, multiple automated plasma arc torches 18 may be mounted to the positioning system 12. The positioning system 12 may be configured to move, translate, and/or rotate the plasma arc torch 18 in any direction (e.g., to provide movement in all degrees of freedom).

Additionally, at least one power supply 14 is operatively connected to the plasma arc torch 18 and configured to supply (or at least control the supply of) electrical power and flows of one or more fluids to the plasma arc torch 18 for operation. Finally, a controller or control panel 16 is operatively coupled to and in communication with the plasma arc torch 18, the one or more power supplies 14, and the positioning system 12. The controller 16 may be configured to control the operations of the plasma arc torch 18, one or more power supplies 14, and/or the positioning system 12, either alone or in combination with the one or more power supplies 14.

In at least some embodiments, the one or more power supplies 14 meter one or more flows of fluid received from one or more fluid supplies before or as the one or more power supplies 14 supply gas to the plasma arc torch 18 via one or more cable conduits. Additionally or alternatively, the automated cutting system 10 may include a separate fluid supply unit (not shown) or units that can provide one or more fluids to the plasma arc torch 18 independent of the one or more power supplies 14. To be clear, as used herein, the term “fluid” shall be construed to include a gas or a liquid. The one or more power supplies 14 may also condition, meter, and supply power to the plasma arc torch 18 via one or more cables, which may be integrated with, bundled with, or provided separately from cable conduits for fluid flows. Additional cables for data, signals, and the like may also interconnect the controller 16, the plasma arc torch 18, the power supply 14, and/or the positioning system 12. Any cable or cable conduit/hose included in the automated cutting system 10 may be any length. Moreover, each end of any cable or cable conduit/hose may be connected to components of the automated cutting system 10 via any connectors now known or developed hereafter (e.g., via releasable connectors).

FIG. 1B illustrates an example embodiment of an automated cutting head 60 that may be used with an automated cutting system executing the techniques presented herein (e.g., the cutting system 10 of FIG. 1A). As can be seen, the cutting head 60 includes a body 62 that extends from a first end 63 (e.g., a connection end 63) to a second end 64 (e.g., an operating or operative end 64). The connection end 63 of the body 62 may be coupled (in any manner now known or developed hereafter) to an automation support structure (e.g., a cutting table, robot, gantry, etc., such as positioning system 12). Meanwhile, conduits 65 extending from the connection end 63 of the body 62 may be coupled to like conduits in the automation support structure (e.g., positioning system 12) to connect the automated cutting head 60 to a power supply, one or more fluid supplies, a coolant supply, and/or any other components supporting automated cutting operations.

At the other end, the operative end 64 of the body 62 may receive interchangeable components, including consumable components 70 that facilitate cutting operations. For simplicity, FIGS. 1A and 1B do not illustrate connections portions of the body 62 that allow consumable components 70 to connect to the torch body 62 in detail. However, it should be understood that the cutting consumables, such as those schematically illustrated in FIG. 1C, may be coupled to a torch body 62 in any manner. Moreover, to be clear, the consumable stack/assembly 70 depicted in FIGS. 1B and 1C (with an external perspective view and a schematic cross-sectional illustration, respectively) is merely representative of a consumable stack that may be used with an automated torch executing the techniques presented herein. Similarly, while none of the Figures of the present application illustrate an interior of the torch body 62, it is to be understood that any unillustrated components that are typically included in a torch, such as components that facilitate cutting operations, may (and, in fact, should) be included in a torch executing example embodiments of the present application.

Now turning to FIG. 1C, this Figure is a simplified/schematic illustration of the consumable stack 70 of FIG. 1B. As mentioned, FIG. 1C illustrates select components or parts that allow for a clear and concise illustration of the techniques presented herein. Specifically, in FIG. 1C, an electrode 82, a nozzle 83, and a shield cap 84 of the consumable stack 70 are depicted. As can be seen, the electrode 82 is disposed at a center of the consumable stack 70 and includes an emissive insert 85 (e.g., formed from hafnium, tungsten, and/or other emissive materials) at a distal end portion thereof. The torch nozzle 83 is generally positioned around the electrode 82. In some embodiments, the nozzle 83 is installed after the electrode 82. Alternatively, the electrode 82 and nozzle 83 can be installed onto the torch body 62 as a single component (e.g., these components may be coupled to each other to form a cartridge and installed on/in the torch body 62 as a cartridge). In either case, the nozzle 83 may be spaced from the electrode 82; or, at least a distal portion of the nozzle 83 may be spaced apart from the distal portion of the electrode 82.

The shield 84 is positioned radially exteriorly of the nozzle 83 and is spaced apart from the nozzle, at least at its distal end. In some embodiments, the shield 84 is installed around an installation flange of the nozzle 83 in order to secure nozzle 83 and electrode 82 in place at (and in axial alignment with) an operating end of the torch body 62. Additionally or alternatively, the nozzle 83 and/or electrode 82 can be secured or affixed to a torch body in any desirable manner, such as by mating threaded sections included on the torch body with corresponding threads included on the components. For example, in some implementations, the electrode 82, nozzle 83, shield 84, as well as any other components (e.g., a lock ring, spacer, secondary cap, etc.) may be assembled together in a cartridge that may be selectively coupled to the torch body, e.g., by coupling the various components to a cartridge body or by coupling the various components to each other to form a cartridge.

In use, a plasma torch is configured to emit a plasma arc 87 between the electrode 82 and a workpiece 89 to which a work lead associated with a power supply is attached (not shown). As shown in FIG. 1C, the nozzle 83 is spaced a distance away from the electrode 82 so that a plasma gas flow channel 90 is disposed therebetween. During piercing and cutting operations, a plasma gas 91 flows through the plasma gas flow channel 90. The shield 84 is also spaced a distance away from the nozzle 83 so that a shield flow channel 92 is disposed between the shield 84 and the nozzle 83, A shield fluid 94 flows through the shield flow channel 92 during at least a portion of the time the plasma torch is operated.

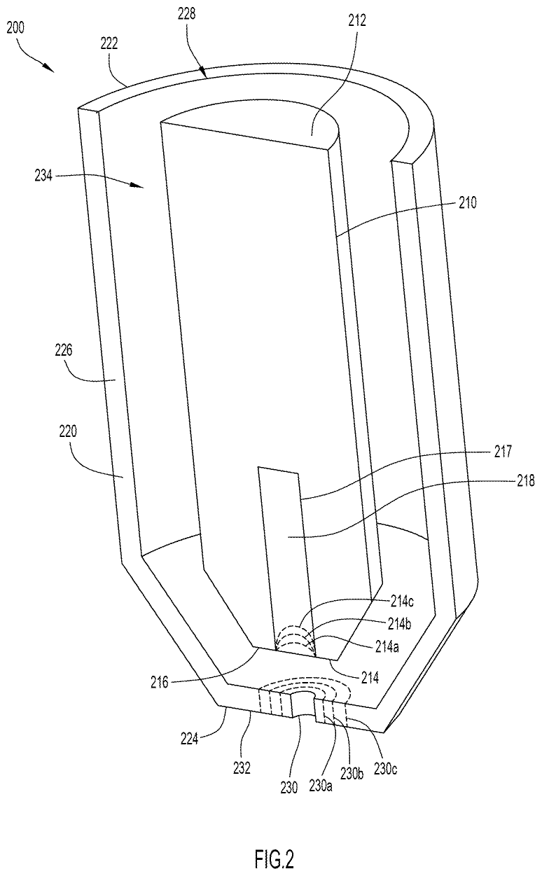

FIG. 2 illustrates a cross-sectional view of at least a portion of a consumable assembly 200. The consumable assembly 200 includes an electrode 210 and a nozzle 220 disposed exteriorly of the electrode 210. The electrode 210 is elongated with a first or proximal electrode end 212 and an opposite second or distal electrode end 214. The second electrode end 214 includes an end face 216 with a cavity 217, within which an emissive insert 218 may be disposed. The nozzle 220 includes a first or proximal nozzle end 222 and an opposite second or distal nozzle end 224. The nozzle 220 further includes a sidewall 226 that extends from the first nozzle end 222 to the second nozzle end 224. As illustrated, a first opening 228 is disposed within the first nozzle end 222 of the nozzle 220, while a second nozzle opening or orifice 230 is disposed within an end face 232 of the second nozzle end 224 of the nozzle 220 such that the end face 216 of the electrode 210 faces the second nozzle opening 230. The first nozzle end 222, the second nozzle end 224, and the sidewall 226 may collectively define an internal volume or internal cavity 234. As illustrated in FIG. 2, the electrode 210 is at least partially disposed within the internal cavity 234 such that the emissive insert 218 is disposed proximate to, and axially aligned with, the nozzle opening 230 of the nozzle 220.

The consumable assembly 200 is configured to couple to a torch body (e.g., the torch body 62) to enable a torch (e.g., the plasma arc torch 18) to direct gas to the consumable assembly 200 during operation of the torch. For example, the torch body is configured to discharge the gas into the internal cavity 234 and toward the second nozzle opening 230. At least for plasma cutting, discharge of the gas through the second nozzle opening 230 facilitates formation of a plasma arc between the consumable assembly 200 and a metal workpiece to perform the processing operation on the metal workpiece.

Different types or embodiments of the consumable assembly 200 may be implemented in the torch. That is, the torch body may be configured to couple to different types of consumable assemblies 200 to perform different processing operations, such as different types of cutting or welding operations based on a desired modification of the metal workpiece. In some embodiments, different types of consumable assemblies 200 may have dissimilar features, such as differently sized and/or shaped end faces 216, emissive inserts 218, and/or second nozzle openings 230. A series of different second electrode end profiles 214a, 214b, 214c of the end face 216 of the electrode 210 are shown in phantom lines. The second electrode end profiles 214a, 214b, 214c represent other possible configurations (e.g., contours) of the end face 216 of the electrode 210 for different types of the consumable assembly 200. Additionally, a series of different second nozzle opening profiles 230a, 230b, 230c of the nozzle 220 are shown in phantom lines. The second nozzle opening profiles 230a, 230b, 230c represent other possible configurations (e.g., opening sizes) of the second nozzle opening 230.

However, to be clear, the profiles illustrated in FIG. 2 illustrate example geometric configurations, and different types of consumable assemblies 200 may include additional or alternative physical features that are different from one another. For example, different embodiments may include various surface formations (e.g., bumps, etchings, knurls), different electrode dimensions (e.g., widths, lengths), different sizes of the internal cavity 234, and so forth. Moreover, different consumable assemblies may include different consumables, either in addition to or instead of the consumables generally illustrated in FIG. 2. For example, welding consumables might comprise a contact tip and distributor, plasma consumables might comprise a shield, shield cap, distributor, spring, etc., and these various consumables may create any desirable gas paths—e.g., flowing in any direction, through any desirable holes, cuts, ridges, etc. Still further, some consumable assemblies 200 might have more than one gas path that are isolated from one or more other gas paths, and any of these gas paths might be utilized to execute the techniques presented herein.

Operation of the torch may cause wear of the emissive insert 218. For example, the plasma arc formed between the consumable assembly 200 and the metal workpiece may contact the emissive insert 218 and increase a temperature of the emissive insert 218 to melt a portion of the emissive insert 218, thereby removing material from the emissive insert 218. As a result, the emissive insert 218 may not fully extend to the end face 216 of the electrode 210, and a space may be formed between the emissive insert 218 and the end face 216. To mitigate such wear of the emissive insert 218 and reduce the space formed between the emissive insert 218 and the end face 216 (e.g., to maintain arrangement of the second electrode end profiles 214a, 214b, 214c), the emissive insert 218 is adjustable. In particular, emissive insert 218 is movable toward the end face 216.

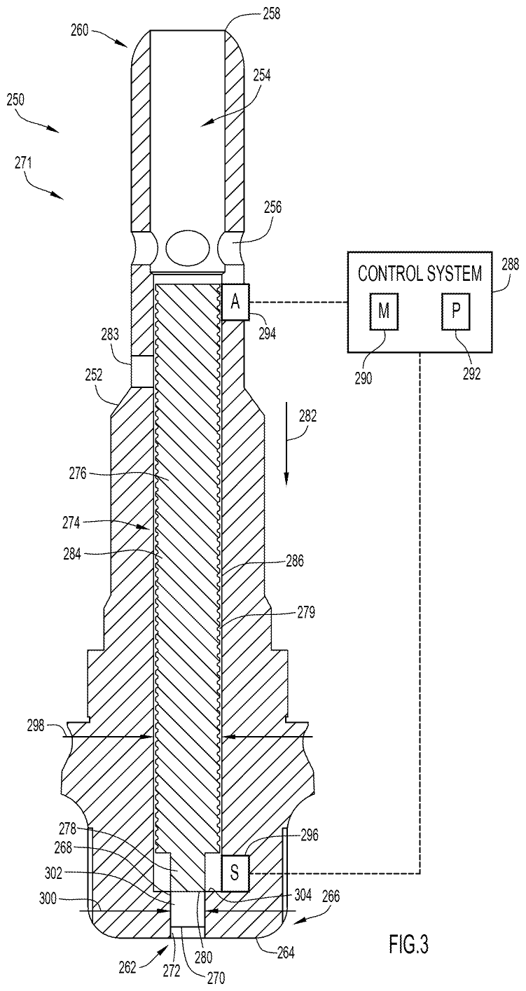

FIG. 3 is a side cross-sectional view of an electrode 250 (e.g., the electrode 210 disposed interiorly of the nozzle 220) of a torch (e.g., the plasma arc torch 18). The electrode 250 includes an electrode body 252 defining an internal chamber 254. For example, at least a portion of the internal chamber 254 may be used for directing gas flow (e.g., toward a nozzle). To this end, pathways 256 extend through the electrode body 252 and into the internal chamber 254 to enable gas flow into and out of the internal chamber 254. The internal chamber 254 is formed through a first electrode surface 258 (e.g., a proximal face, a first external surface) at a first end 260 (e.g., a proximal end) of the electrode body 252, the first electrode surface 258 and the first end 260 facing or being positioned at where the electrode 250 is connected to a remainder of the torch.

The electrode 250 also includes a recess 262 formed through a second electrode surface 264 (e.g., a distal face, a second external surface) at a second end 266 (e.g., a distal end) of the electrode body 252, the second electrode surface 264 and the second end 266 facing or being positioned adjacent to an opening of a nozzle while the torch is assembled. An emissive insert 268 of the electrode 250 is positioned within the recess 262. During operation of the torch, the electrode 250 generates a plasma arc that emanates from a first insert surface 270 (e.g., a distal insert surface, an external insert surface) of the emissive insert 268 adjacent to the second electrode surface 264 toward a metal workpiece, such as through an opening of the nozzle. The emissive insert 268 shields the electrode body 252 from the heat of the plasma arc to help sustain the plasma arc.

In the illustrated embodiment, the electrode 250 is in a first configuration 271 (e.g., a worn configuration, an unadjusted configuration) in which the first insert surface 270 is misaligned with or offset from the second electrode surface 264, thereby creating a space 272 between the first insert surface 270 and the second electrode surface 264. In other words, the emissive insert 268 terminates within the recess 262 prior to reaching the second electrode surface 264. For example, the plasma arc extending from the first insert surface 270 may elevate the temperature of the emissive insert 268 and cause material to be removed from the emissive insert 268 (e.g., via a melting process). The misalignment between the emissive insert 268 and the electrode body 252 may reduce heat shielding of the electrode body 252 via the emissive insert. Additionally, the space 272 between the first insert surface 270 and the second electrode surface 264 may create a vacuum or suction pressure in which the pressure within the space 272 is lower than a pressure outside of the space 272 (e.g., a pressure surrounding the electrode body 252). The vacuum pressure may further accelerate wear of the emissive insert 268. By way of example, the vacuum pressure may urge movement of the emissive insert 268 (e.g., melted material of the emissive insert 268) out of the recess 262. Consequently, the vacuum pressure may cause additional removal of material from the emissive insert 268.

To reduce the misalignment between the first insert surface 270 and the second electrode surface 264, thereby reducing a size of the space 272, the emissive insert 268 may be moved toward the second electrode surface 264. In other words, the emissive insert 268 is movable relative to the electrode body 252 to bring the first insert surface 270 toward alignment with the second electrode surface 264. To this end, a rod 274 is positioned within the internal chamber 254 and is configured to drive movement of the emissive insert 268. For example, the rod 274 may include a base 276 and an extension 278 extending from the base 276. The base 276 is configured to contact first sidewalls 279 (e.g., first internal walls) of the electrode body 252 to block undesirable movement of the rod 274 within the internal chamber 254, thereby maintaining positioning of the rod 274 in the electrode 250, and/or to block gas flow between the base 276 and the first sidewalls 279, thereby directing gas through the plasma torch along a desirable flow path (e.g., toward the opening of the nozzle). The extension 278 is configured to abut a second insert surface 280 (e.g., a proximal insert surface, an internal insert surface) of the emissive insert 268. The rod 274 is configured to move in a direction 282 within the internal chamber 254 toward the second electrode surface 264 of the electrode body 252. Such movement of the rod 274 causes the extension 278 to impart a force onto the second insert surface 280 to drive corresponding movement of the emissive insert 268 toward the second electrode surface 264. As a result, the first insert surface 270 is moved toward alignment with the second electrode surface 264 to reduce the space 272.

In some embodiments, the rod 274 is movable within the internal chamber 254 via a manually applied force. By way of example, the rod 274 may be accessible via the internal chamber 254 (e.g., at the first end 260, at the pathways 256, at an opening 283 aligned with the base 276 along the direction 282) to enable a force to be applied to the rod 274 to move the rod 274 in the direction 282. For instance, a separate tool may be inserted into the internal chamber 254 to apply the force. In certain embodiments, the base 276 is threadedly engaged with the first sidewalls 279 of the electrode body 252. That is, the base 276 includes threads 284 (e.g., external threads) that engage with corresponding threads 286 (e.g., internal threads) of the first sidewalls 279. In such embodiments, rotating the rod 274 relative to the electrode body 252 drives movement of the rod 274 in the direction 282. Additionally or alternatively, the rod 274 is configured to translate along the electrode body 252 in the direction 282. As an example, the base 276 engages with the first sidewalls 279 in an interference fit (e.g., a slip fit) and can slide/translate along the first sidewalls 279 in response to a sufficiently applied force, such as via a press (e.g., inserted through the opening 283). In any case, a user may manually move the emissive insert 268 relative to the electrode body 252, such as between cutting operations.

In additional or alternative embodiments, the rod 274 is automatically movable within the internal chamber 254. To this end, the electrode 250 includes or is communicatively coupled to a control system 288. The control system 288 includes a memory 290 and a processor 292 (e.g., processing circuitry). The memory 290 includes read only memory (ROM) or other static storage device (e.g., programmable ROM (PROM), erasable PROM (EPROM), electrically erasable PROM (EEPROM)), random access memory (RAM) or other dynamic storage devices (e.g., dynamic RAM (DRAM), static RAM (SRAM), and synchronous DRAM (SD RAM)), magnetic disk storage media devices, optical storage media devices, flash memory devices, electrical, optical, and/or other physical/tangible (e.g., non-transitory) memory storage devices. Thus, in general, the memory 290 includes one or more computer readable storage media (e.g., a memory device) encoded with software with computer executable instructions that may be executed to effectuate the operations described herein. The processor 292 includes a collection of microcontrollers and/or microprocessors, for example, each configured to execute respective software instructions stored in the memory 290. The processor 292 may also include special purpose logic devices (e.g., application specific integrated circuits (ASICs)) or configurable logic devices (e.g., simple programmable logic devices (SPLDs), complex programmable logic devices (CPLDs), field programmable gate arrays (FPGAs)), that, in addition to microprocessors and digital signal processors may individually, or collectively, are types of processing circuitry. Portions of the memory 290 (and the instructions therein) may be integrated with the processor 292. The processor 292 performs a portion or all of the processing steps to execute the techniques presented herein, e.g., in response to instructions contained in the memory 290. In alternative embodiments, hard-wired circuitry may be used in place of or in combination with software instructions. Thus, embodiments are not limited to any specific combination of hardware circuitry and software. Put another way, the control system 288 includes at least one computer readable medium or memory for holding instructions programmed according to the embodiments presented, for containing data structures, tables, records, or other data described that might be required to execute the techniques presented herein.

The control system 288 is communicatively coupled to an actuator 294 and is configured to instruct the actuator 294 to move the rod 274 in the direction 282. For example, the control system 288 may also be communicatively coupled to a sensor 296 configured to monitor a position of the first insert surface 270 relative to the second electrode surface 264. The control system 288 is configured to receive sensor data from the sensor 296 and determine an alignment between the first insert surface 270 and the second electrode surface 264 based on the sensor data. In response to determining there is a substantial misalignment between the first insert surface 270 and the second electrode surface 264 (e.g., a distance between the first insert surface 270 and the second electrode surface 264 is above a threshold value) based on the data, the control system 288 is configured to instruct the actuator 294 to move the rod 274, thereby driving movement of the emissive insert 268 toward the second electrode surface 264 (e.g., until the distance between the first insert surface 270 and the second electrode surface 264 is below the threshold value). As such, the control system 288 is automatically configured to move the rod 274 to maintain alignment between the first insert surface 270 and the second electrode surface 264 in response to sensor data received from the sensor 296. However, in some embodiments, the control system 288 is configured to receive a user input and instruct the actuator 294 to move the rod 274 based on the user input, such as regardless of sensor data received from the sensor 296.

In the illustrated embodiment, a first distance 298 spanning between the first sidewalls 279 at the internal chamber 254 is greater than a second distance 300 spanning between second sidewalls 302 (e.g., second internal walls) at the recess 262. The difference between the first distance 298 and the second distance 300 provides a lip 304 of the electrode body 252 between the first sidewalls 279 and the second sidewalls 302. As further discussed herein, such an arrangement of the first sidewalls 279 relative to the second sidewalls 302 may help indicate positioning of the rod 274 within the electrode body 252. However, in alternative embodiments, the first sidewalls 279 at the internal chamber 254 may have any suitable arrangement with respect to the second sidewalls 302 at the recess 262 (e.g., the first sidewalls 279 may be aligned with the second sidewalls 302).

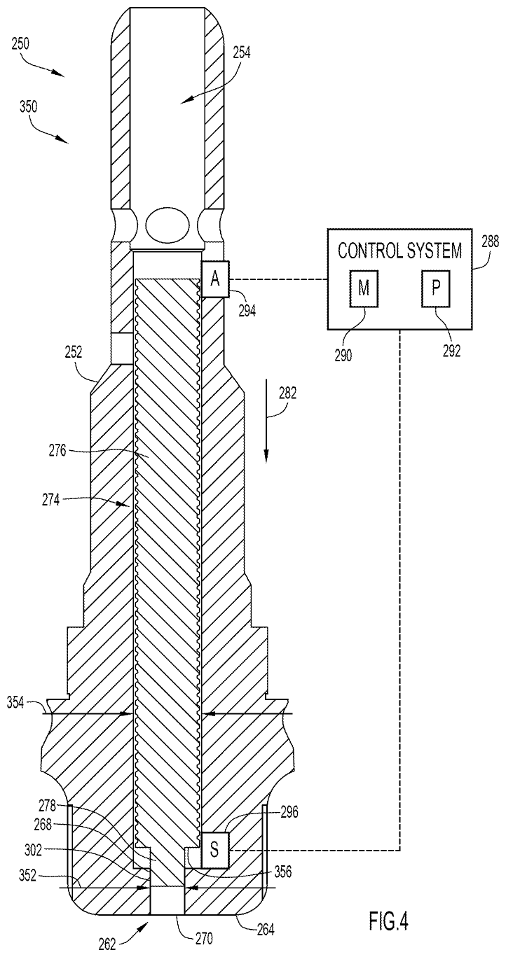

FIG. 4 is a side cross-sectional view of the electrode 250 in a second configuration 350 (e.g., an adjusted configuration). In the second configuration 350, the first insert surface 270 of the emissive insert 268 is approximately aligned with (e.g., collinear to, coplanar to, flush with) the second electrode surface 264 to substantially eliminate the space 272 between the first insert surface 270 and the second electrode surface 264. Thus, the emissive insert 268 may provide desirable heat shielding of the electrode body 252 and/or accelerated wear of the emissive insert 268 (e.g., otherwise caused by a vacuum pressure) may be avoided. As an example, movement of the rod 274 in the direction 282 may transition the electrode 250 from the first configuration 271 to the second configuration 350.

In some embodiments, the extension 278 of the rod 274 may at least partially extend into the recess 262 in the second configuration 350. To this end, a first thickness 352 of the extension 278 is less than a second thickness 354 of the base 276 to enable the extension 278 to be positioned between the second sidewalls 302 at the recess 262. For example, the second thickness 354 of the base 276 may be substantially equal to the first distance 298 spanning between the first sidewalls 279 (see FIG. 3) to enable the base 276 to maintain contact with the first sidewalls 279, and/or the first thickness 352 of the extension 278 may be substantially equal to the second distance 300 spanning between the second sidewalls 302 (see FIG. 3) to enable the extension 278 to maintain contact with the second sidewalls 302 in the second configuration 350. The reduced size of the first thickness 352 relative to the second thickness 354 provides a shoulder 356 of the rod 274 facing the second electrode surface 264. Additionally, the rod 274 is positioned within the internal chamber 254 to align (e.g., axially align, concentrically align) the extension 278 with the recess 262 to enable movement of the rod 274 along the direction 282 to insert the extension 278 into the recess 262.

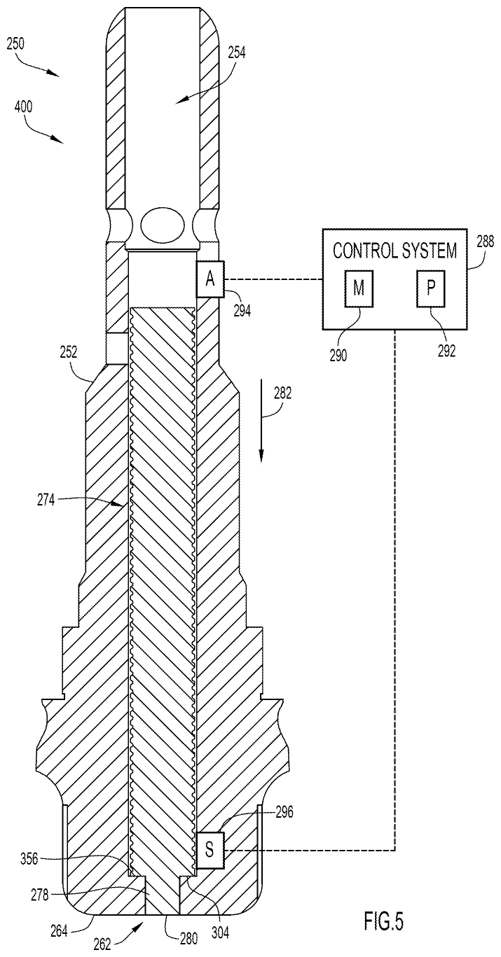

FIG. 5 is a side cross-sectional view of the electrode 250 in a third configuration 400 (e.g., a fully extended configuration). In the third configuration 400, the shoulder 356 of the rod 274 is in abutment with the lip 304 of the electrode body 252. By way of example, further movement of the rod 274 in the direction 282 may transition the electrode 250 from the second configuration 350 to the third configuration 400, such as in response to additional wear of the emissive insert 268 after transitioning the electrode 250 to the second configuration 350. The abutment of the shoulder 356 against the lip 304 blocks further movement of the rod 274 in the direction 282.

As an example, abutment of the shoulder 356 against the lip 304 may indicate the emissive insert 268 has been fully worn. In other words, the extension 278 is exposed exterior to the electrode 250 at the recess 262 and/or the second insert surface 280 is aligned with the second electrode surface 264. Thus, the abutment of the shoulder 356 against the lip 304 may indicate the electrode body 252 is exposed to excessive heat and that the electrode 250 is to be replaced. For instance, contact of the shoulder 356 with the lip 304 may provide tactile feedback or sensation that better informs the user to replace the electrode 250 instead of, for example, continuing to try to move the rod 274 in the direction 282.

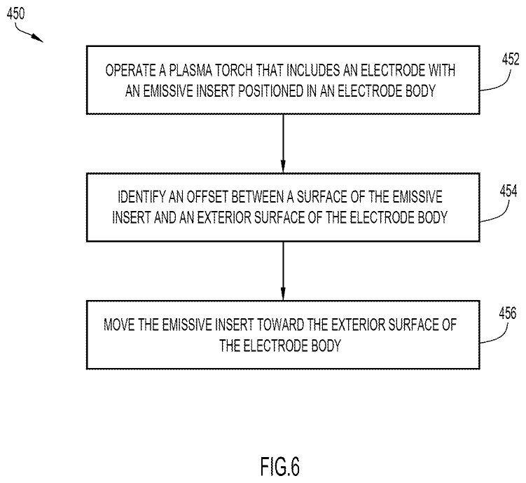

FIG. 6 is a flowchart of a method 450 for adjusting an electrode, such as any of the electrodes discussed herein, of a plasma torch. It should be noted that the method 450 may be performed differently than depicted. For example, an additional operation may be performed, and/or any of the depicted operations may be performed differently, may be performed in a different order, and/or may not be performed.

At block 452, a plasma torch that includes an electrode with an emissive insert positioned in an electrode body is operated. During operation of the plasma torch, a plasma arc is generated to remove material from a metal workpiece. Alignment between an insert surface of the emissive insert and an external surface of the electrode (e.g., in which the insert surface and the external surface are flush with one another) may be desirable to shield the electrode body from heat generated by the plasma arc. However, contact between the emissive insert and the plasma arc may remove material from the emissive insert, thereby causing wear of the emissive insert and potentially reducing heat shielding provided by the emissive insert.

Wear of the emissive insert may cause a surface of the emissive insert to become misaligned with or offset from the external surface of the electrode. At block 454, the offset between the insert surface of the emissive insert and the external surface of the electrode body is identified. By way of example, a sufficient distance between the insert surface and the external surface is detected.

At block 456, in response to identification of the offset between the insert surface of the emissive insert and the external surface of the electrode body, the emissive insert is moved toward the external surface of the electrode body. By way of example, the electrode may include a rod positioned within the electrode body and in contact with the emissive insert. The rod may be movable to drive corresponding movement of the emissive insert toward the external surface of the electrode body. In some embodiments, the rod is threadedly engaged with the electrode body such that rotation of the rod causes movement of the rod toward the external surface. In additional or alternative embodiments, the rod is configured to translate or slide along the electrode body to move the emissive insert toward the external surface of the electrode body. In either case, movement of the emissive insert may align the insert surface with the external surface of the electrode body to enable the emissive insert to desirably heat shield the electrode body and/or to impede additional wear of the emissive insert. In additional or alternative embodiments, the emissive insert may be moved toward the external surface of the electrode body using another technique. For instance, at least a portion of the emissive insert may be melted (e.g., using a current) and flowed toward the external surface of the electrode body. The emissive insert may then be solidified to align with the external surface of the electrode body.

Operations of the method 450 may be repeated. For example, as the emissive insert continues to wear to cause an offset between the insert surface of the emissive insert and the external surface of the electrode body, the emissive insert may be moved again toward the external surface of the electrode body. Thus, the emissive insert may be continually moved to maintain alignment between the insert surface of the emissive insert and the external surface of the electrode body. However, in some circumstances, the emissive insert may no longer be usable (e.g., the emissive insert has been fully worn). In response, the electrode may be replaced. By way of example, abutment between the rod and a portion of the electrode body (e.g., between a shoulder of the rod and a lip of the electrode body) may indicate the emissive insert is no longer usable to prompt replacement of the electrode.

The proposed technology would allow an emissive insert of an electrode of a plasma torch to be moved, such as into alignment with an external surface of an electrode body. Such movement of the emissive insert relative to the electrode body maintains desirable heat shielding of the electrode body to maintain a structural integrity of the electrode body to prolong a useful lifespan of the electrode. Additionally, movability of the emissive insert to align with the electrode body hinders wear of the emissive insert, further prolonging the useful lifespan of the electrode.

While the apparatuses and methods presented herein have been illustrated and described in detail and with reference to specific embodiments thereof, it is nevertheless not intended to be limited to the details shown, since it will be apparent that various modifications and structural changes may be made therein without departing from the scope of the disclosure and within the scope and range of equivalents of the claims. Additionally, the methods presented herein may be suitable for any type of welding and/or cutting consumable assemblies, including consumable assemblies utilized for automated (e.g., mechanized) and/or manual (e.g., handheld) operations.

In addition, various features from one of the embodiments may be incorporated into another of the embodiments. That is, it is believed that the disclosure set forth above encompasses multiple distinct embodiments with independent utility. While each of these embodiments has been disclosed in a preferred form, the specific embodiments thereof as disclosed and illustrated herein are not to be considered in a limiting sense as numerous variations are possible. The subject matter of the disclosure includes all novel and non-obvious combinations and subcombinations of the various elements, features, functions, and/or properties disclosed herein. Accordingly, it is appropriate that the appended claims be construed broadly and in a manner consistent with the scope of the disclosure as set forth in the following claims.

It is also to be understood that terms such as “left,” “right,” “top,” “bottom,” “front,” “rear,” “side,” “height,” “length,” “width,” “upper,” “lower,” “interior,” “exterior,” “inner,” “outer,” “internal,” “external,” and the like as may be used herein, merely describe points of reference and do not limit the present disclosure to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the disclosure. Additionally, it is also to be understood that the components of the apparatuses described herein, the consumable assemblies described herein, or portions thereof may be fabricated from any suitable material or combination of materials, such as plastic or metals (e.g., copper, bronze, hafnium, etc.), as well as derivatives thereof, and combinations thereof. In addition, it is further to be understood that the steps of the methods described herein may be performed in any order or in any suitable manner.

Finally, when used herein, the term “comprises” and its derivations (such as “comprising”, etc.) should not be understood in an excluding sense, that is, these terms should not be interpreted as excluding the possibility that what is described and defined may include further elements, steps, etc. Similarly, where any description recites “a” or “a first” element or the equivalent thereof, such disclosure should be understood to include incorporation of one or more such elements, neither requiring nor excluding two or more such elements. Meanwhile, when used herein, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about”, “around”, “generally”, and “substantially.”

In the following detailed description, reference is made to the accompanying figures which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the description herein. Alternate embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

What is claimed is:

1. A plasma torch, comprising:
a nozzle comprising an opening; and
an electrode disposed interiorly of the nozzle and configured to generate a plasma arc and direct the plasma arc through the opening of the nozzle, wherein the electrode comprises:
an electrode body; and
an emissive insert disposed in the electrode body, wherein the emissive insert is movable relative to the electrode body.

2. The plasma torch of claim 1, wherein the emissive insert of the electrode is configured to move toward an exterior surface of the electrode body, the exterior surface of the electrode body facing the opening of the nozzle.

3. The plasma torch of claim 1, comprising a rod disposed in the electrode body and in abutment with the emissive insert, wherein the rod is configured to move within the electrode body to move the emissive insert relative to the electrode body.

4. The plasma torch of claim 3, wherein the rod is threadedly coupled to internal threads of the electrode body, and the rod is configured to rotate relative to the electrode body to move via the internal threads.

5. The plasma torch of claim 3, wherein the rod is configured to translate relative to the electrode body.

6. The plasma torch of claim 3, wherein the emissive insert has an exterior surface and an interior surface, the rod is in abutment with the interior surface of the emissive insert, and the electrode is configured to generate the plasma arc to emanate from the exterior surface.

7. The plasma torch of claim 1, comprising a gas pathway formed through the electrode body, wherein the emissive insert is movable relative to the electrode body away from the gas pathway.

8. An electrode for a plasma torch, the electrode comprising:
an electrode body comprising an internal chamber and a distal face with a recess;
an emissive insert disposed in the recess; and
a rod disposed in the internal chamber and in abutment with the emissive insert, wherein the rod is configured to move within the internal chamber to move the emissive insert within the recess.

9. The electrode of claim 8, wherein the rod is configured to move within the internal chamber toward the distal face of the electrode body to move the emissive insert within the recess toward the distal face.

10. The electrode of claim 9, wherein the rod is configured to rotate to move within the internal chamber toward the distal face of the electrode body.

11. The electrode of claim 8, wherein at least a portion of the rod is configured to extend into the recess to move the emissive insert within the recess.

12. The electrode of claim 11, wherein the rod comprises a base and an extension, the base is configured to engage with an internal wall of the electrode body in the internal chamber, and the at least a portion of the rod configured to extend into the recess comprises the extension.

13. The electrode of claim 12, wherein a thickness of the base is greater than a thickness of the extension.

14. The electrode of claim 13, wherein the thickness of the base being greater than the thickness of the extension provides a shoulder of the rod, the electrode body comprises a lip formed between the internal wall of the electrode body in the internal chamber and an additional internal wall of the electrode body in the recess, and the shoulder of the rod is configured to abut the lip of the electrode body to block further movement of the rod toward the distal face.

15. The electrode of claim 8, wherein the internal chamber is configured to receive and direct a gas through the plasma torch.

16. A plasma torch, comprising:
an electrode body comprising an internal chamber; and
a rod disposed within the internal chamber, wherein the rod is configured to move within the internal chamber to adjust a position of an emissive insert relative to the electrode body.

17. The plasma torch of claim 16, wherein the rod comprises a base configured to engage an internal wall of the electrode body at the internal chamber, the rod comprises an extension extending from the base, and a first thickness of the base is greater than a second thickness of the rod.

18. The plasma torch of claim 16, wherein the electrode body comprises a recess configured to receive the emissive insert.

19. The plasma torch of claim 18, wherein the electrode body comprises first internal walls at the internal chamber and second internal walls at the recess, and a first distance between the first internal walls is greater than a second distance between the second internal walls to provide a lip between the first internal walls and the second internal walls.

20. The plasma torch of claim 16, wherein the rod is engaged with the electrode body via an interference fit, and the rod is configured to translate along the electrode body to move within the internal chamber.
